(19) United States
(12) Patent Application Publication
(10) Pub. No.: US 2015/0158594 A1
(43) Pub. Date: Jun. 11, 2015

(54) COOLING CONCEPT BACK PANEL

(71) Applicant: SELL GMBH, Herborn (DE)

(72) Inventor: Frank Weixler, Rabenau (DE)

(21) Appl. No.: 14/413,094

(22) PCT Filed: Jun. 21, 2013
(86) PCT No.: PCT/EP13/62999

§ 371 Date: Jan. 6, 2015

Related U.S. Application Data
(60) Provisional application No. 61/673,855, filed on Jul. 20, 2012.

(51) Int. Cl. B64D 13/08; B64D 11/04

(52) U.S. Cl. CPC B64D 13/08; B64D 11/04

(57) ABSTRACT

The invention relates to an aircraft galley (1) comprising at least one cooling compartment (2) for receiving a container for foods and/or drinks to be cooled, characterized in that at the back of the galley (1) at least one panel (3) with integrated cooling ducts (6, 7) is mounted, said panel being connected to a source of cooling air (5) and an air exhaust structure. In the panel, at least one air exhaust opening (3a) oriented towards the cooling compartment (2) and at least one cooling air opening (3b) oriented towards the cooling compartment (2) are provided, the at least one cooling air opening (3b) being provided above the at least one air exhaust opening (3a).

### 1. FIELD OF THE INVENTION

The invention relates to an aircraft galley having at least one cooling compartment for holding one or more containers of consumable items to be cooled. Containers of this type can be any type of insertable containers, tablets, or trolleys, such as those typically used in aircraft to stock the galleys.

### 2. PRIOR ART

Supplying the needs of passengers in aircraft, in particular, providing them with consumable provisions such as beverages and food, is done with what are known as aircraft galleys that have a plurality of compartments in which the consumable provisions can be placed as needed. These consumable provisions are typically supplied to the aircraft for each flight in so-called trolleys, movable containers, and then inserted into dedicated compartments in the aircraft galley where they are secured so as to prevent them from possibly falling out. These containers that contain perishable goods, or the contents of which need to be cooled for other reasons, either have their own separate cooling units or must be cooled by other means inside the aircraft galley.

Many devices are thus already well known in practice whose cooling compartments can be cooled. However, the structural design of these cooling devices is very costly and furthermore does not allow for any quick reconfiguration of the aircraft galley as a function of changing requirements. A further goal typically sought is to ensure that cooling of the cooling compartments is uniform across the entire width and depth of the cooling compartment, a goal that can only be reliably achieved in practice by very expensive means.

However the disadvantage of these aircraft galleys is the fact that they can be reconfigured only with difficulty or by costly means if larger or smaller compartments are required as a function of the length of the flight or quantity of consumable provisions to be cooled.

### 3. OBJECT OF THE INVENTION

The object of the invention is therefore to provide an aircraft galley that is of simple construction and that at the same time can provide reliable cooling of its cooling compartments that also vary in size. This object is attained according to the is invention by an aircraft galley comprising the features of claim 1. Advantageous embodiments of the invention are seen in the dependent claims.

### 4. SUMMARY OF THE INVENTION

According to the invention, one panel each is provided on the back of the galley and is connected to a cool-air opening and an exhaust-air opening, and at least one exhaust-air opening directed into the cooling compartment and at least one cool-air opening directed into the cooling compartment are provided. The at least one cool-air opening is provided here above the at least one exhaust-air opening.

The construction according to the invention first of all ensures that the cooling compartment remains essentially of identical form with regard to volume relative to non-cooled compartments, while at the same time, however, a preferably permanent flow of cooling air is reliably provided through the compartment, but also through appropriate inserts in the cooling compartment that have openings that correspond to the exhaust-air opening and cool-air opening within the panel. This approach ensures that the entire cooling compartment, or at least the container stored in it, can be cooled completely and by simple means. In particular, the construction according to the invention enables the aircraft galley to be reconfigured as a function of the requirements and the desired size and number of cooling compartments.

In a preferred embodiment of the invention, the at least one exhaust-air opening is directed toward the bottom of the cooling compartment, while the at least one cool-air opening is directed toward the top of the cooling compartment. This ensures that there is a precise flow of cooling air from top to bottom through the cooling compartment, in particular through a container provided therein. This also ensures that the cooling air introduced into the cooling compartment or the container flows so as to completely surround the consumable provisions to be cooled.

In another preferred embodiment of the invention, the at least one exhaust-air opening and the at least one cool-air opening are provided with a connection fitting, preferably one having a circumferential gasket of a shape and size that corresponds to the openings and optional connection fittings, in particular to the circumferential gaskets on the container intended for the cooling compartment. This provides a construction for an aircraft galley that ensures that cooling air that is introduced from the panel and exhaust air is discharged through the panel flows as intended completely through the cooling compartment and/or through the container provided therein without leakage.

Since the construction of the aircraft galley is provided in such a way that the cooling air is to flow through containers inserted into the cooling compartment, modular construction can be especially advantageously supported in this preferred embodiment of the invention, in that the connection fittings are shaped such that inserting the containers into the cooling compartment causes them to interact directly and automatically with the cool-air openings and the exhaust-air openings in the container.

The especially preferred approach here is one whereby the connection fittings have mechanisms by which they can be precisely closed and opened, either individually or altogether. An especially preferred embodiment of the invention is able to achieve this, for example, by a ventilation-grid-like design of the connection fittings in which a plurality of louvers can be pivoted from a first open position that allows for the virtually unobstructed passage of cooling air and/or exhaust air through the connection fittings to a closed position in which the louvers, while slightly overlapping each other, completely cover the area of the opening within the connection fitting. What is most preferred is a connection fitting that is provided with this type of ventilation-grid-like design comprising a circumferential gasket that, for example, interacts with a corresponding gasket on an opening, or on a connection fitting on a container that can be inserted into the cooling compartment.

In another preferred embodiment of the invention, the multiple exhaust-air openings are provided inside the panel, preferably uniformly across the width of the cooling compartment. This ensures by simple means a uniform flow of cooling air through the cooling compartment or the container located in the cooling compartment.

The approach is also preferred whereby the multiple cool-air openings are provided in the panel, preferably uniformly across the width of the cooling compartment. This also ensures a uniform io flow of air through the compartment or through the container provided in the cooling compartment.

The approach is furthermore preferred whereby the panel has cool-air ducts and exhaust-air ducts, it being especially preferred that the exhaust-air ducts are provided on the edge of the panel. This creates a panel in which the supply and discharge of cooling air of exhaust air can be implemented within the smallest possible space, while at the same time any warming of the panel by the heated exhaust air is restricted to a minimum and, in particular, to the wall regions of the panel. As a result, the cooling performance through the panel into the cooling compartment is thus maintained essentially without any losses.

The approach is also preferred whereby the connection from the panel to the cool-air source and the exhaust reservoir—preferably a heat exchanger, is via flexible hoses, which approach enables the connection of the panel to the cool-air sources and the exhaust air reservoir to be implemented in a highly variable way and also over long distances.

The approach is furthermore preferred whereby the cool-air source is provided on the top or the bottom of the aircraft galley. The cool-air source can be a generating unit for cooling air; however, the cool-air source as defined by the invention can also be a connection interface to a cool-air supply provided on board. In any case, this creates an aircraft galley that is of space-saving construction and in which the cool-air supply can be implemented without reducing the storage space of the aircraft galley.

In another preferred embodiment of the invention, the depth of the panel does not exceed 4.57 cm, preferably 4.32 cm. In particular, what is preferred is for the free depth of the cooling compartment to measure at least 86.36 cm, thereby ensuring that the cooling compartment is also capable of accommodating standardized is trolleys.

### 5. BRIEF DESCRIPTION OF THE FIGURES

The invention is described in the following in more detail with reference to two figures that depict a preferred embodiment of the invention. In the figures:

FIG. 1 is an exploded view of the aircraft galley according to the invention; and

FIG. 2 is a schematic view of an aircraft galley when assembled.

### 6. DETAILED DESCRIPTION

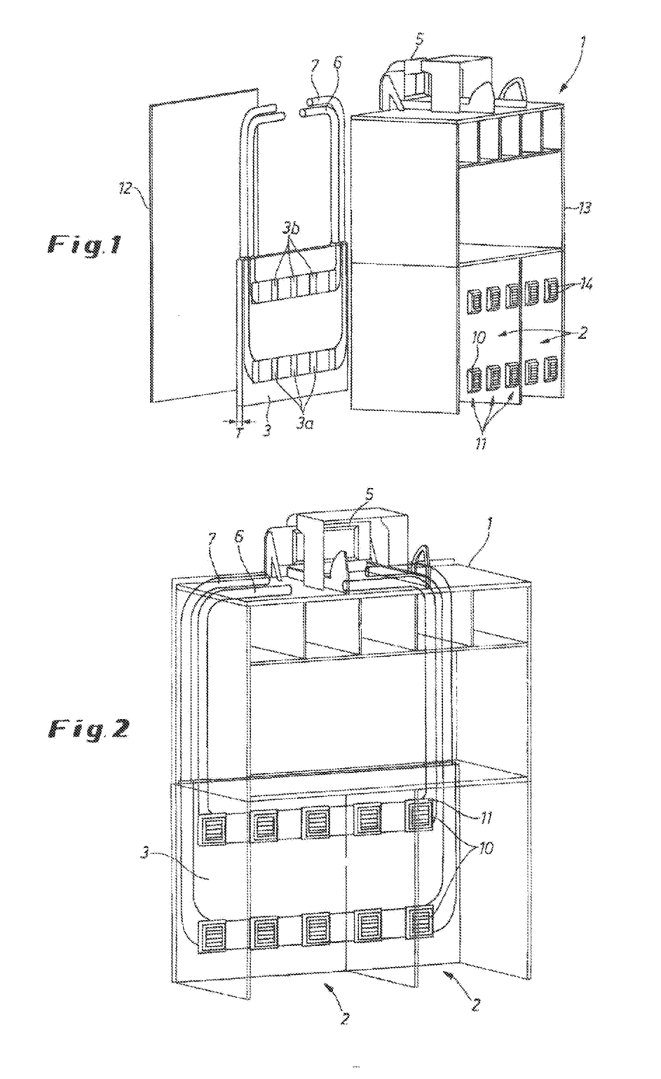

FIG. 1 is an exploded view of an aircraft galley 1 according to the invention that has a galley housing 13 and a back \wall 12. A panel 3 is provided between the back wall 12 and the housing 13 and when assembled is provided behind cooling compartments 2 of the galley 1. The panel 3 whose depth T is 4.32 cm (1.7 in) has a row of cool-air supply openings 3b that are provided above a row of exhaust-air openings 3a. Exhaust air is discharged from the compartments 2 through the exhaust-air openings 3a and exhaust-air ducts provided at the edge of the panel 3. The ducts are connected to exhaust pipes 7 that in turn feed into a connection 5 for an exhaust-air reservoir or heat exchanger. The upper row of cool-air openings 3b is supplied through flexible hoses 6 from a cool-air source 5 with cool air that then flows through connection fittings 11 into the compartments 2, or directly into containers (not shown) that have been inserted into the compartments 2 and preferably locked there in place such that the connection fittings 11 fit with respective container-side connections in such a way that the cooling air and the exhaust air are transported directly and without any leakage into and out of the containers. Each connection fitting 11 is of essentially square shaped and is shaped like a ventilation grid with pivoting louvers 14. These louvers 14 in the form shown extend parallel and one above the other within the connection fitting 11 to enable the cooling air and the exhaust air to essentially pass unobstructed through the connection fitting 11. However, the louvers 14 can also be pivoted about their longitudinal axis so that they rest on each other in at least partially overlapping fashion, thereby completely closing the respective connection fitting 11. Each individual connection fitting 11 can preferably be controlled separately, or at least each connection fitting 11 that is associated with a particular the compartment 2 and/or a particular container.

FIG. 2 is a schematic view of the galley 1 in the assembled state where the connection fittings 11 together with gaskets 10 surrounding them are provided on the panel 3 on the openings (not shown) for supplying cooling air to the compartments 2 and discharging exhaust air from the compartments 2. The supply of cooling air from the cool-air source 5 to the panel 3 is through the flexible hoses 6 that terminate in a supply tube inside the panel 3. The exhaust air drawn from the compartments 2 moves analogously through exhaust-air ducts that are provided in the panel 3 and on the edge of the panel, and through flexible hoses 7 to an exhaust air reservoir preferably in the form of a heat exchanger.

References:

| | | | |
|---|---|---|---|
| 1 | aircraft galley | 7 | exhaust-air duct |
| 2 | cooling compartment | 9 | hose |
| 3 | panel | 10 | gasket |
| 3a | exhaust-air opening | 11 | connection fittings |
| 3b | cool-air opening | 12 | back wall |
| 5 | cool-air source | 13 | galley housing |
| 6 | cool-air duct | 14 | louvers |

1. An aircraft galley comprising:
a housing defining at least one cooling compartment for holding a container of consumable items to be cooled;
a panel on the back of the and formed with integrated air ducts and having at least one exhaust-air opening opening into the cooling compartment and at least one cool-air opening opening into the cooling compartment, the at least one cool-air opening being provided above the at least one exhaust-air opening
a cool-air source connected through the ducts to the cool-air opening; and
an exhaust-air outlet connected through the ducts to the exhaust-air opening.

2. The aircraft galley according to claim 1, wherein the at least one exhaust-air opening is directed toward the bottom of the cooling compartment and the at least one cool-air opening is directed toward the top of the cooling compartment.

3. The aircraft galley according to claim 1, wherein the at least one exhaust-air opening and the at least one cool-air opening are each provided with a connection fitting having a circumferential gasket that in shape and size corresponds to the openings on the container intended for the cooling compartment.

4. The aircraft galley according to claim 1, wherein multiple exhaust-air openings are distributed within the panel in a row uniformly across the width of the cooling compartment.

5. The aircraft galley according to claim 1, wherein multiple cool-air openings are distributed within the panel in a row uniformly across the width of the cooling compartment.

6. The aircraft galley according to claim 1, wherein the panel has cool-air ducts and exhaust-air ducts.

7. The aircraft galley according to claim 6, wherein at least the exhaust-air ducts are provided on the edge of the panel.

8. The aircraft galley according to claim 1, wherein the panel is connected to the cool-air source and an exhaust air reservoir by flexible hoses.

9. The aircraft galley according to claim 1, wherein the cool-air source is provided on the top or the bottom of the aircraft galley.

10. The aircraft galley according to claim 1, wherein a depth of the panel does not exceed 4.57 cm.

11. The aircraft galley according to claim 1, wherein a free depth of the cooling compartment measures at least 86.36 cm.
